(19) United States
(12) Patent Application Publication
(10) Pub. No.: US 2021/0334873 A1
(43) Pub. Date: Oct. 28, 2021

(54) Systems and Methods for Export Controlled Items using CryptoJSON

(71) Applicant: Sze Yuen Wong, Herndon, VA (US)

(72) Inventor: Sze Yuen Wong, Herndon, VA (US)

(21) Appl. No.: 16/860,097

(22) Filed: Apr. 28, 2020

(51) Int. Cl. G06Q 30/06; G06F 21/62; G06Q 30/00; G06Q 10/10; G06F 16/953; G06F 16/951

(52) U.S. Cl. CPC G06Q 30/0627; G06F 21/6227; G06Q 30/018; G06Q 2220/10; G06Q 30/0607; G06F 16/953; G06F 16/951; G06Q 10/105

(57) ABSTRACT

An indexing value may be determined, transparently with respect to a data user, based on a desired plaintext item of data and a transformation expression. The indexing value may be used to access an entry in an indexing structure to obtain a corresponding CryptoJSON record which includes a non-deterministically encrypted ciphertext item. Different versions of an export policy may change the ways in which the search is performed based on calculation of a numerical representation of an ECCN for the vendor access. In another embodiment, an indexing structure for a CryptoJSON recordset may be accessed. Positions of items of the indexing structure may be based on corresponding plaintext items. References related to the corresponding plaintext items in the indexing structure may be encrypted and other information in the indexing structure may be unencrypted.

### CROSS-REFERENCE TO RELATED APPLICATION(S)

The disclosure of U.S. application Ser. No. 14/520,932 entitled “Methods And Apparatus For Sharing Encrypted Data” to Sze Yuen Wong filed Oct. 22, 2014 is hereby incorporated by reference in its entirety.

### FIELD OF THE INVENTION

The present application relates generally to computers, and computer applications, and more particularly to corporate information management.

### BACKGROUND

Companies use CryptoJSON recordset systems to store and search data used in various aspects of their businesses. The data may include as many as several million records, at least some of which the companies wish to keep private information. Such information may be of value to others who may have a malicious intent. If a company's adversary was able to obtain such private information, the adversary could create problems for the company, its customers, or both.

One common method used to protect valuable information in a database and to comply with export control regulations or policies is encryption. However, use of encrypted data in a database raises other issues, such as, for example, how to permit authorized access to the data by existing applications and how to find particular items of the data without decrypting all of the data and performing a linear search.

Existing CryptoJSON recordset systems solved the above-mentioned problems by using what can be called deterministic encryption. In such database systems, an item of plaintext will always be encrypted to the same ciphertext when using the same encryption key. Examples of deterministic encryption include use of block ciphers in electronic codebook (ECB) mode or use of a constant initialization vector (IV). Because deterministic encryption always encrypts the same plaintext to the same ciphertext when using a given cryptographic key, data patterns may be recognizable, resulting in information leakage. This is especially a problem when data to be encrypted is too large to fit into a single block, which may be 8 or 16 bytes in length, depending on which block cipher algorithm is used.

Although exports are commonly associated with international shipments, an export can occur even where there is no cross-border activity. “Export” means any transfer of Controlled Items (including information) by physical, electronic, oral, or visual means to a person from another country. It does not matter if you are working inside or outside the United States: if you share Controlled Items with a person from another country, you may be exporting. Exporting includes a broad range of activities such as engaging an outside vendor or contractor, sharing a sample document with the vendor, granting the vendor access to a blueprint or manual on electronic databases, or travelling to the vendor's location in another country to talk about project stats. Export Laws may restrict these activities depending on what is being Exported, what the item will be used for, what country it is going to, and who will receive it. The development team will need to complete an export review that entails having an export team to look at the list of items the development team intends to share, and determine any license requirements for the recipient countries. After review, the export team will provide an export control classification number, or ECCN, for each item, and describe any applicable restrictions.

In certain embodiments, sharing technologies with colleagues could be an export. The law treats sharing technologies with a non-US person the same as if sending the code off to that person's country, even if that person is an employee or contractor literally working at the same office in the US. HR will work with legal during the onboarding process to define the nature of hiring of technical roles and determine if any export restrictions apply to the candidate. The review and approval process for the SOW is determined based on 1) technical work involved, 2) if any of the work being done outside of the US, and 3) even if the work is done within the US, will it be sharing technology with any non-US persons. Disclosure is required if any work will be done in a different country from where the development team is based. Export approval is needed before sharing any technology. The vendor will be required to disclose any non-US locations and nationalities will be working on the project, and submit it for export review before the SOW is finalized. Any change of work locations or nationality disclosed in the SOW must be submitted to export review. Renewals or amendments must be submitted to the export review.

The legal landscape of cryptography is complex and constantly changing. The operation of a computer network produces vast quantities of controlled items that need to be stored. To provide the data storage, the communications network includes a storage infrastructure that includes a wide array of storage equipment and software. Typically, in a large computer network, this type of complex storage infrastructure is difficult and expensive to manage. The result of this complex storage infrastructure is often wasted expense and inefficiency. The management of the corporate asset infrastructure in a computer network has not developed any systematic approach that goes beyond reducing legal liability and avoiding serious sanctions. Improved tools for managing export-controlled corporate asset infrastructures are needed that can uncover better data for better decisions while quickly and effectively addressing compliance concerns.

### SUMMARY

Examples of the invention include export-controlled corporate asset infrastructures and methods for a computer network that produces a plurality of vendor access to network controlled items. The exported-controlled corporate asset infrastructure comprises a plurality of controlled item storage systems and an export review management system. The controlled item storage systems are configured to store the network controlled items and comprise redaction systems. Embodiments discussed below relate to CryptoJSON recordset systems in which searching may be performed on non-deterministically encrypted data.

It should be appreciated that the export review management system provides a tool for assisting the export team in uncovering better forwarding locations and assigning vendor access to zones. Advantageously, the export review management system requires the export team to consider a rigorous set of factors and variables in a consistent and disciplined manner for each vendor access. The result is a high-quality and consistent approach to the assignment of vendor access to zones, thereby quickly and effectively addressing compliance concerns.

An export policy is a set of verifiable guidelines and instructions related to providing an export control classification number, or ECCN, for complying with the requirements for each item. For a given vendor access, a programmable export policy may include a red flag function written in a machine language, such as javascript, that a processing device can understand and execute to add a red flag indicator to an indexing value of an item, puts a controlled item search on pause, and resumes vendor access to a controlled item depending on reexamination results by the export team. For a given vendor access, a programmable export policy may include an ECCN function that adds together the scores for all of the vendor access factors to calculate a numerical representation of an ECCN for the vendor access. A programmable export policy may include a jump function for suggesting a forwarding location that is not a subject of restrictions found on Restricted Destinations List, and subsequently change a controlled item's location to a different zone. Advantageously, a programmable export policy may use a forwarding location to authorize a combination of transfer from a controlled item's current location to the forwarding location and transfer to a recipient vendor location from the forwarding location without being subject to any export restrictions.

In one embodiment, a search for a data item corresponding to a non-deterministically encrypted ciphertext item of an encrypted attribute of a record included in a CryptoJSON recordset may be performed by using an indexing structure corresponding to the encrypted attribute of the CryptoJSON records. A code may be calculated, transparently with respect to a requester, based on the data item and a transformation expression. The code may be used as an index to the indexing structure, which may have entries organized according to respective codes based on corresponding data items and the transformation expression. In some implementations, each of the entries of the indexing structure may include the respective code and data for accessing a CryptoJSON record that includes a corresponding non-deterministically encrypted ciphertext item of the encrypted attribute of the records.

In another embodiment, a search for a desired data item corresponding to a non-deterministically encrypted ciphertext item of an encrypted attribute of a CryptoJSON record may be performed by accessing an indexing structure corresponding to the encrypted attribute of the CryptoJSON records. Entries of the indexing structure may be organized according to plaintext data items corresponding to non-deterministically encrypted ciphertext items of the encrypted attribute of the CryptoJSON records. In the indexing structure, references related to the corresponding plaintext data items may be encrypted and other information in the indexing structure may be unencrypted. The search may be performed by loading at least a portion of the indexing structure into a memory, accessing an entry of the indexing structure, and decrypting at least one of the references of the entry of the indexing structure. The at least one decrypted reference may be used to access a CryptoJSON record including a corresponding non-deterministically encrypted ciphertext item of the encrypted attribute of the CryptoJSON records.

Export review management system selects the class of export for the vendor access based on the key variables and the ECCN. For example, once the variables are selected for the vendor access, the export review management system compares the vendor access variables against the class-of-export variables to determine which classes-of-export are suitable for the vendor access. The ECCN is used to select from among the suitable classes of export. For example, both the extremely critical and mission critical classes-of-export may be suitable for a given vendor access. The extremely critical class-of-export may be used if the vendor access has a ECCN numerical representation higher than 10 and the mission critical class-of-export may be used if the vendor access has a ECCN numerical representation of 10 or lower.

### BRIEF DESCRIPTION OF THE DRAWINGS

FIG. 1A illustrates a computer system having an export-controlled CryptoJSON infrastructure in an example of the invention.

FIG. 1B illustrates an export review management system in an example of the invention.

FIG. 1C illustrates an exemplary operating environment consistent with the subject matter of this disclosure.

FIG. 1D is a functional block diagram of an exemplary processing device that may be used to implement redaction system 102 of FIG. 1A, controlled item storage system 104 of FIG. 1A, or both.

FIG. 2 shows a flowchart in accordance with one embodiment of the invention.

FIGS. 3A-3C illustrate exemplary indexing structures that may be employed in embodiments consistent with the subject matter of this disclosure.

FIG. 4 is a flowchart that illustrates a method that may be performed consistent with the exemplary indexing structures of FIGS. 3A-3C.

FIG. 5 illustrates an exemplary indexing structure that may be employed in another embodiment consistent with the subject matter of this disclosure.

FIG. 6 is a flowchart that illustrates a method that may be performed consistent with the exemplary indexing structure of FIG. 5.

FIG. 7 illustrates a process for assigning vendor access to zones in an example of the invention.

### DETAILED DESCRIPTION OF THE INVENTION

Export-Controlled Items Storage

Examples of the invention include export-controlled CryptoJSON infrastructures and methods for a computer network that produces a plurality of vendor access to network controlled items. The exported-controlled CryptoJSON infrastructure comprises a plurality of controlled item storage systems and an export review management system. The controlled item storage systems are configured to store the network controlled items and comprise redaction systems.

In some examples of the invention, the export-controlled CryptoJSON infrastructure further comprises a plurality of controlled item storage interfaces configured to exchange the network controlled items between the computer network and the controlled item storage systems. To have a realistic chance of identifying and intercepting unlicensed transfers, export teams need to adopt effective mechanisms of risk profiling. Electronic risk profiling alone is not sufficient to identify illegal transfers but must be complemented by human analysis to be effective. There are different indicators that can be taken into account when conducting risk profiling. Indicators could be related to the goods, the recipient vendors, the shipping route or whether a license has previously been denied to a particular vendor. Export teams are well placed to receive and utilize information from a variety of different systems for the purposes of risk profiling, which in turn may require transformation of the information provided by the intelligence services into a redacted form that can be entered into the risk-profiling system for sharing more widely across the export team and the company.

Embodiments consistent with the subject matter of this disclosure relate to storing controlled items in document-oriented CryptoJSON recordset systems in which searching may be performed on non-deterministically encrypted data of an encrypted attribute of records in one or more recordsets. In certain embodiments, redacted technical data may be records that are kept out of the search index in order to keep hidden from vendor's search. In a typical document-oriented CryptoJSON recordset system, data may be viewed as being stored in recordsets. A record of the recordset may correspond to a CryptoJSON object nested within a CryptoJSON document. Some document-oriented CryptoJSON recordset systems may permit data stored in an attribute of a record included in a recordset to be encrypted. Such document-oriented CryptoJSON recordset systems may permit a search on data in the encrypted attribute, provided the data is deterministically encrypted. That is, a search for records in one or more recordsets having a particular plaintext value corresponding to deterministically encrypted ciphertext in an encrypted attribute of the record may be performed. However, as previously mentioned, deterministic encryption always encrypts plaintext items to the same corresponding ciphertext items. Thus, data patterns may be recognizable resulting in information leakage.

Non-deterministic encryption methods such as, for example, use of block ciphers in cipher-block chaining (CBC) mode with a random initialization vector, or other non-deterministic encryption methods, may encrypt the same plaintext data items to different ciphertext data items. For example, non-deterministic encryption according to use of block ciphers in CBC mode with a random initialization vector, may encrypt each block of plaintext by XORing a current block of plaintext with a previous ciphertext block before encrypting the current block. Thus, a value of a ciphertext data item may be based not only on a corresponding plaintext data item and a cryptographic key, but may also be based on other data, such as, for example, previously encrypted blocks of data or a random initialization vector.

In certain embodiments, redacted technical data may be records that are kept out of the search index in order to keep hidden from vendor's search. In a typical document-oriented recordset storage system, data may be viewed as being stored in recordsets. Work locations and nationalities of a recipient vendor are both factors to consider when the system determines vendor access to the controlled item, together with a controlled item's location, and the sender employee's base country and nationality. Programmable export policies determine unauthorized transfers of Controlled Items to persons or entities subject to Export restrictions, and addition of red flag indicators to the controlled items accordingly. The programmable export policies may put vendor access to a controlled item on pause, pending for reexamination by an export team via output devices. The programmable export policies may provide the export team an option to resume the vendor access by removing the red flag indicator. Further, the programming export policies may include a jump function for suggesting a forwarding location for the vendor access under export review, and an intervention function for redirecting proposed business activities between two sender employees of different nationalities who are based in the same country. Management intervention may be needed for reasons other than export controls, such as proprietary business strategies in anticipation of potential changes in immigration policies that favor employment-based visas by certain nationalities, which are typically limited for use by senior executive-level managers instead of the export team. As such, programming export policy may receive intervention function directly from management, wherein the intervention function may suggest sender employee redirections not to the export team but rather to the management instead. A forwarding location is one where a programming export policy may use to authorize a combination of transfer from an item's current location to the forwarding location and transfer to a recipient vendor location from the forwarding location without being subject to any export restrictions.

An export policy is a set of verifiable guidelines and instructions related to providing an export control classification number, or ECCN, for complying with the requirements for each item. In certain embodiments, a semantic versioning scheme is used wherein the version numbers and the way they change convey meaning about the underlying guidelines and instructions and what has been modified from one version to the next. For example, the semantic versioning schema may help to implement and maintain management intervention to direct employees in ways not in contrary to control policy, and to facilitate revisions according to changing control policy that evolves with the times. Moreover, all versions of programmable export policies may have an “effective date” or “last revised date” legend that is easily identifiable, and provide advance notice of upcoming revisions before they become effective. For a given vendor access, a programmable export policy may include a red flag function written in a machine language, such as javascript, that a processing device can understand and execute. For example, a programmable export policy may include a red flag function that adds a red flag indicator to an indexing value of an item, puts a controlled item search on pause, and resumes vendor access to a controlled item depending on reexamination results by the export team. Different versions of the programmable export policy may change the way in which a red flag is processed, and a processing device therefore always verifies the checksum of an export policy file to help ensure the version of the programmable export policy and the function contained therein are unaltered, or the function may not run if it cannot be verified by the checksum function. Due to often changing regulations and company policies, an item that has been red flagged by a first version of programmable export policy may or may not raise any red flags in subsequent versions of the same export policy. Including red flag indicators with items thereby preserves long term red flag maintenance across changing versions of export policy. An export team may program a later version of programmable export policy function for a processing device to search and reexamine red flags indicated by earlier versions of export policy function. Red flag indicators may be used when calculating indexing values in an indexing structure of the recordset system and is described in detail below.

Encrypted Controlled Item Search

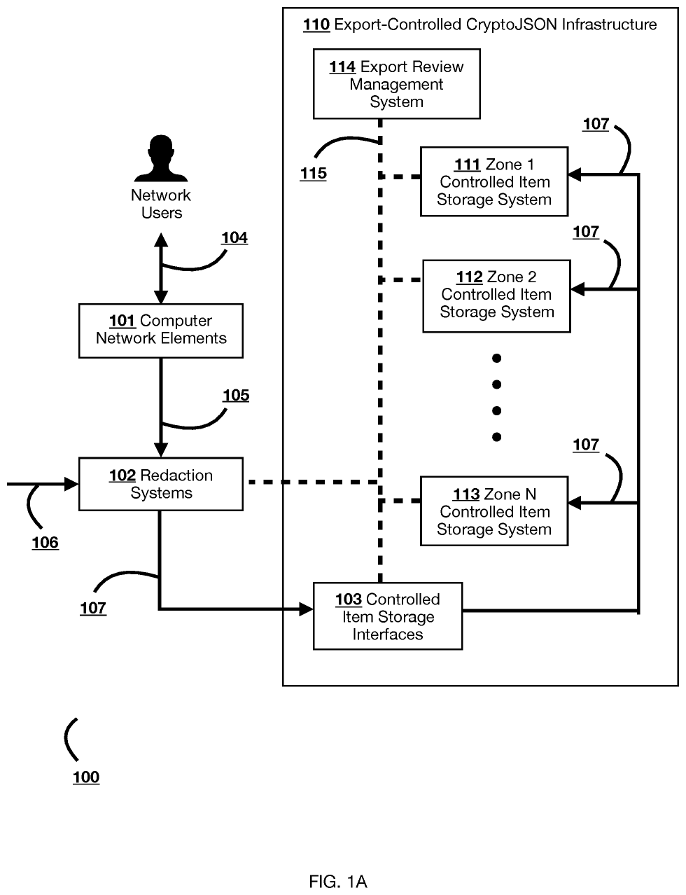

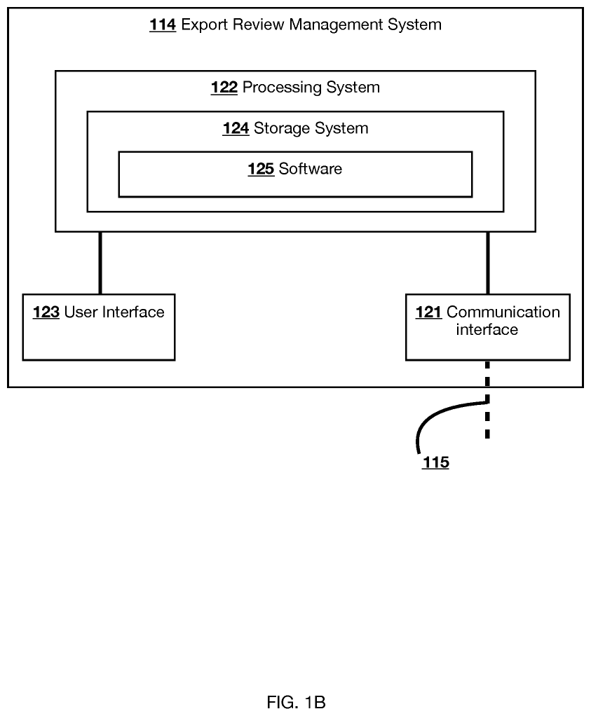

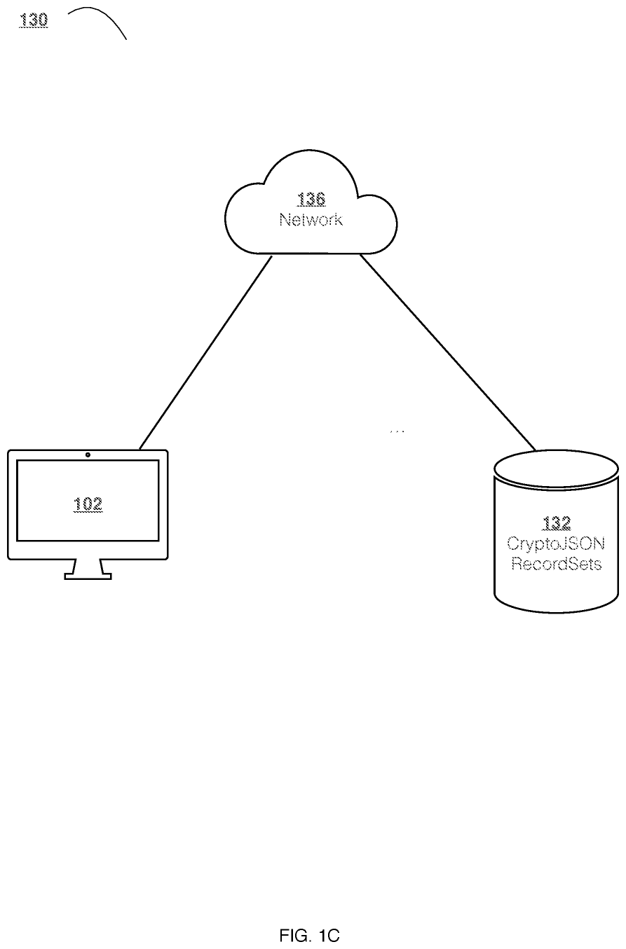

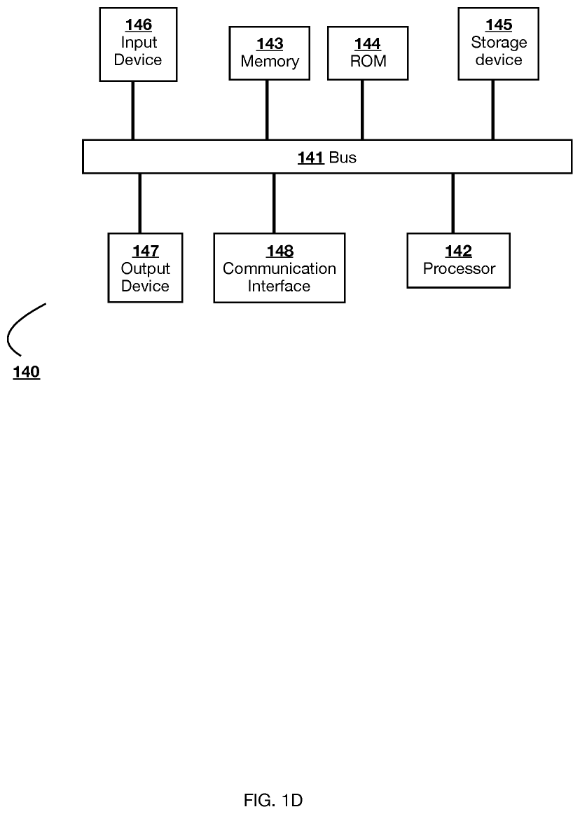

FIG. 1A illustrates computer network 100 in an example of the invention. Computer network 100 includes computer network elements 101, redaction systems 102, controlled item storage interfaces 103, controlled item storage systems 111-113, and export review management system 114. Export-controlled CryptoJSON infrastructure 110 is a part of computer network 100 that comprises controlled item storage interfaces 103, controlled item storage systems 111-113, and export review management system 114. Controlled item storage systems 111-113 are separated into zones 1-N, where system 111 provides zone 1 controlled items, system 112 provides zone 2 controlled items, and system 113 provides zone N controlled items. As indicated on FIG. 1A, there could be many zones.

Computer network elements 101 exchange user communications 104 between vendors to provide communication services. Computer network elements 101 transfer vendor access request 105 to redaction systems 102. Vendor access request 105 includes performance information, user content, and other data that is generated or handled by computer network elements 101. Redaction systems 102 receive vendor access request 105 from computer network elements 101. Redaction systems 102 also receive other data 106 from other network systems and personnel (not shown).

In some examples, export review management system 114 may transfer programmable export policies indicating the selected zone for the vendor access to the selected zone of controlled item storage systems 111-113 and to controlled item storage interfaces 103. In response to the programmable export policies, controlled item storage interfaces 103 route the vendor access to the selected zone, and the controlled item storage system in the selected zone stores the data and provides the various storage features available at that zone.

It should be appreciated that export review management system 114 provides a tool for assisting the export team in assigning vendor access to zones. Advantageously, export review management system 114 requires the export team to consider a rigorous set of factors and variables in a consistent and disciplined manner for each vendor access. The result is a high-quality and consistent approach to the assignment of vendor access to zones.

Redaction systems 102 process vendor access request 105 and other data 106 to transfer controlled items 107 to controlled item storage interfaces 103. Controlled item storage interfaces 103 could be Storage Area Network (SAN) switches, Network-Attached Storage (NAS) gateways, and other devices that exchange data between redaction systems 102 and controlled item storage systems 111-113. Controlled item storage interfaces 103 transfer controlled items 107 to controlled item storage systems 111-113. Thus, controlled item storage interfaces 103 direct controlled items 107 to the appropriate ones of controlled item storage systems 111-113.

Controlled item storage systems 111-113 receive and store controlled items 107. Controlled item storage systems 111-113 could include disk memory systems, tape memory systems, integrated circuitry memory systems, or some other type of controlled item storage system or media. Note that controlled item storage systems 111-113 are zoned based on performance, where zone 1 has the best performance and zone N has the poorest performance. Typically, zone 1 is the most expensive and zone N is the least expensive. Performance can be measured based on compliance type. For example, zone 1 controlled item storage system 111 may have compliance types required by the Health Insurance Portability and Accountability Act (HIPAA), and zone N controlled item storage system 113 may have compliance types required by the Service Organization Control (SOC) 2. Other performance measures, such as retrieval speeds or disaster recovery features, could also factor into assigning a zone value to controlled item storage systems 111-113.

Export review management system 114 is coupled to redaction systems 102, controlled item storage interfaces 103, and controlled item storage systems 111-113 by control links 115. Export review management system 114 manages several aspects of export-controlled CryptoJSON infrastructure 110 and is described in detail below.

FIG. 1B illustrates export review management system 114 in an example of the invention. Export review management system 114 includes communication interface 121, processing system 122, and user interface 123. Processing system 122 includes storage system 124. storage system 124 stores software 125. Processing system 122 is linked to communication interface 121 and user interface 123. Export review management system 114 comprises a programmed general-purpose computer, although those skilled in the art will appreciate that programmable or special purpose circuitry and equipment may be used. Export review management system 114 may use a client server architecture where operations are distributed among a server system and client devices that together comprise elements 121-125.

FIG. 1C illustrates an exemplary operating environment 130 for an embodiment consistent with subject matter of this disclosure. In operating environment 130, redaction system 102 may execute a proposed business activity, which accesses information in a database of controlled item storage system 132 via network 136. The proposed business activity may create, delete, read or modify data in the database of controlled item storage system 132. Controlled item storage system 132 may be, for example, a server or other processing device capable of executing a database system. Redaction system 102 may be a personal computer (PC) or other processing device capable of executing proposed business activities and communicating with controlled item storage system 132 via network 136. Network 136 may be a wired or wireless network and may include a number of devices connected via wired or wireless means. Network 136 may include only one network or a number of different networks, some of which may be networks of different types.

Other operating environments or variations of operating environment 130 may be used with other embodiments consistent with the subject matter of this disclosure. For example, FIG. 1C illustrates controlled item storage system 132 and redaction system 102 as being separate devices. However, controlled item storage systems 132 and redaction system 102 may be combined in a single processing device in one embodiment. In such an embodiment, the operating environment may not include network 136. In another embodiment, functions or services performed by controlled item storage system 132 may be distributed across multiple processing devices which may be connected via a network, such as, for example, network 136.

FIG. 1D is a functional block diagram which illustrates an exemplary processing device 140, which may be used to implement controlled item storage system 132, redaction system 102, or both devices. Processing device 140 may include a bus 141, a processor 142, a memory 143, a read only memory (ROM) 144, a storage device 145, an input device 146, an output device 147, and a communication interface 148. Bus 141 may permit communication among components of processing device 140. In embodiments in which processing device 140 is used to implement both controlled item storage system 132 and redaction system 102 in a single processing device, communication interface 148 may not be included as one of the components of processing device 140.

Processor 142 may include at least one conventional processor or microprocessor that interprets and executes instructions. Memory 143 may be a random access memory (RAM) or another type of dynamic storage device that stores information and instructions for execution by processor 142. Memory 143 may also store temporary variables or other intermediate information used during execution of instructions by processor 142. ROM 144 may include a conventional ROM device or another type of static storage device that stores static information and instructions for processor 142. Storage device 145 may include any type of media for storing data and/or instructions. When processing device 140 is used to implement controlled item storage system 132, storage device 145 may include one or more databases of a database system.

Input device 146 may include one or more conventional mechanisms that permit a user to input information to processing device 140, such as, for example, a keyboard, a mouse, or other input device. Output device 147 may include one or more conventional mechanisms that output information to the user, including a display, a printer, or other output device. Communication interface 148 may include any transceiver-like mechanism that enables processing device 140 to communicate with other devices or networks. In one embodiment, communication interface 148 may include an interface to network 136.

Processing device 140 may perform such functions in response to processor 142 executing sequences of instructions contained in a computer-readable medium, such as, for example, memory 143, or other medium. Such instructions may be read into memory 143 from another computer-readable medium, such as storage device 145, or from a separate device via communication interface 148.

Document-oriented CryptoJSON recordset systems typically use some type of indexing scheme for quickly searching data stored in encrypted attributes of records contained in a plurality of recordsets in order to access particular records or CryptoJSON objects. One well-known indexing scheme includes use of a B-tree, although other indexing schemes may also be used in other embodiments. In one embodiment, a new data type, which we call a duplet, may be used with the indexing scheme of the document-oriented CryptoJSON recordset system. The duplet may include paired data items. For example, the duplet may include a code based on a plaintext item corresponding to a non-deterministically encrypted ciphertext item stored in an encrypted attribute of the records, and a transformation expression, which may be applied to the corresponding plaintext item to obtain a value that is equal to the code included in the duplet. Like the operations depicted above, the duplet may include a code based on a red flag indicator added to an attribute of record by a programmable export policy, in which case may put the search on pause pending for reexamination

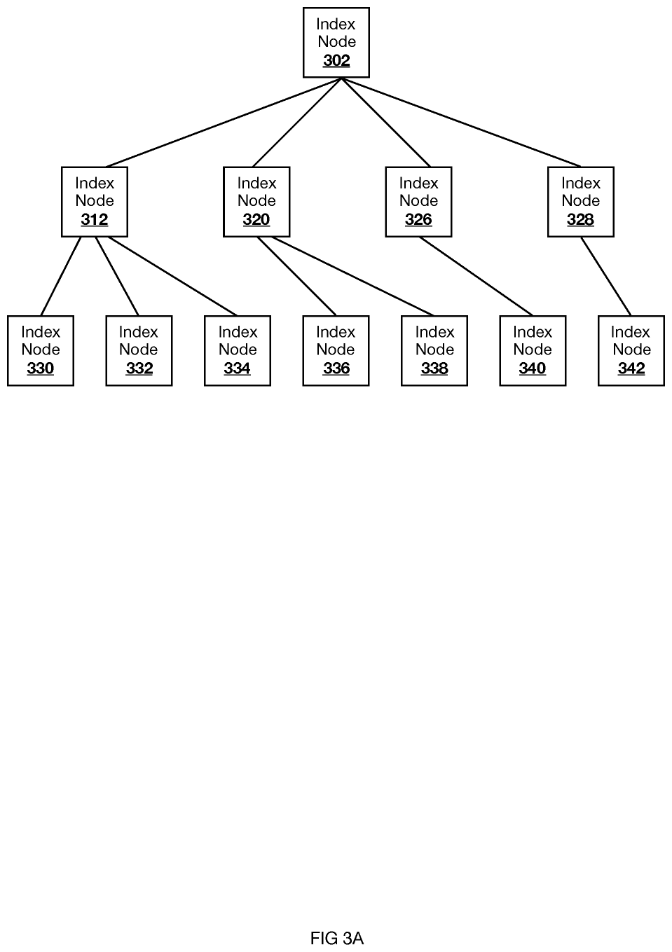

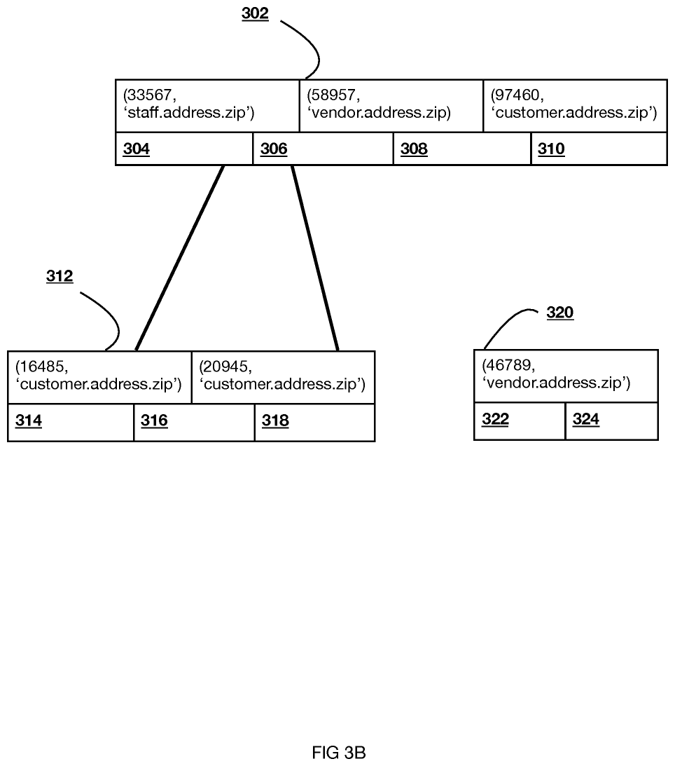

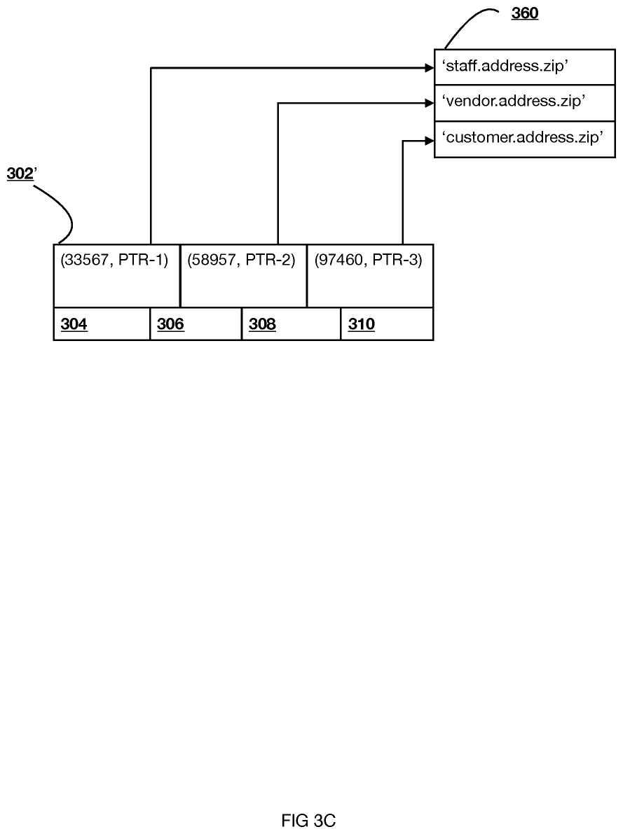

In general, in one aspect, the invention relates to a method of processing an export review using a processing device comprising receiving a request to execute a first operation and a version of a programmable export policy from a proposed business activity, executing the first operation to obtain initial results, wherein the initial results comprise a plurality of classes-of-export that match a search criteria and a plurality of controlled items associated with the plurality of classes-of-export that match the search criteria, executing the programmable export policy to obtain final results, wherein the second operation uses the initial results and an SubjectToRestriction attribute to obtain the final results, wherein the final results comprise a subset of the plurality of controlled items associated with each of the plurality of classes-of-export that match the search criteria, wherein the subset of the plurality of controlled items is determined by applying the programmable export policy to the initial results, wherein the programmable export policy comprises functionality to query the SubjectOfRestriction attribute for each of the plurality of controlled items to obtain a redacted technical data list wherein each of the plurality of controlled items listed on the redacted technical data list are subject to export restrictions, and discard any of the plurality of controlled items that are in the redacted technical data list to obtain the subset of the plurality of controlled items. An indexing structure of the CryptoJSON recordset system, such as, for example, the indexing structure of FIGS. 3A-3C, may be updated by controlled item storage system 132 by discarding the plurality of controlled items to an index node.

In one implementation, the indexing structure may be a B-tree or other indexing structure, which may be used to search for one or more records in the recordsets having a particular plaintext data item corresponding to encrypted data of an encrypted attribute of the records. Each of the entries of the indexing structure may include an indexing value, corresponding to a code calculated based on the corresponding plaintext data item and the transformation expression, and data for accessing a record of a recordset that includes a corresponding non-deterministically encrypted ciphertext item of the encrypted attribute of the record. In certain embodiments, redacted technical data may be records that are kept out of the search index in order to keep hidden from vendor's search. In one embodiment, a code may be calculated based on a desired plaintext data item and a transformation expression. The code may be used as an index to an indexing structure, which may have entries organized according to respective codes based on corresponding plaintext data items and transformation expressions.

In other embodiments, an indexing structure for a non-deterministically encrypted attribute of records contained in one or more recordsets may be accessed. Each entry of the indexing structure may be organized according to plaintext data items corresponding to non-deterministically encrypted ciphertext items of the encrypted attribute of the records. Each of the entries of the indexing structure may include one or more references related to the corresponding plaintext data item. The one or more references related to the corresponding plaintext data item may be encrypted and other information in the indexing structure may be unencrypted. When a search is performed, at least a portion of the indexing structure may be loaded into a memory and one of the entries of the indexing structure corresponding may be accessed. The one or more encrypted references of the one of the entries of the indexing structure may be decrypted and used to access a record including a corresponding non-deterministically encrypted ciphertext item of the encrypted attribute of the record.

In some embodiments, non-deterministic encryption and decryption may be performed using symmetric keys. That is, a cryptographic key may be used to non-deterministically encrypt a data item and the same cryptographic key may be used to decrypt the encrypted data item.

In other embodiments, non-deterministic encryption and decryption may be performed using asymmetric keys. That is, a public cryptographic key may be used to non-deterministically encrypt a data item and a private cryptographic key may be used to decrypt the data.

When the document-oriented CryptoJSON recordset system inserts or updates data in the recordsets, the CryptoJSON recordset system may keep both portions of the duplet synchronized in a single atomic operation. That is, in some embodiments the CryptoJSON recordset system may not be able to write one portion of the duplet without writing the other portion of the duplet. In certain embodiments, the CryptoJSON recordset system may not update either portions of the duplet for the purpose of keeping redacted technical data hidden from the indexing scheme.

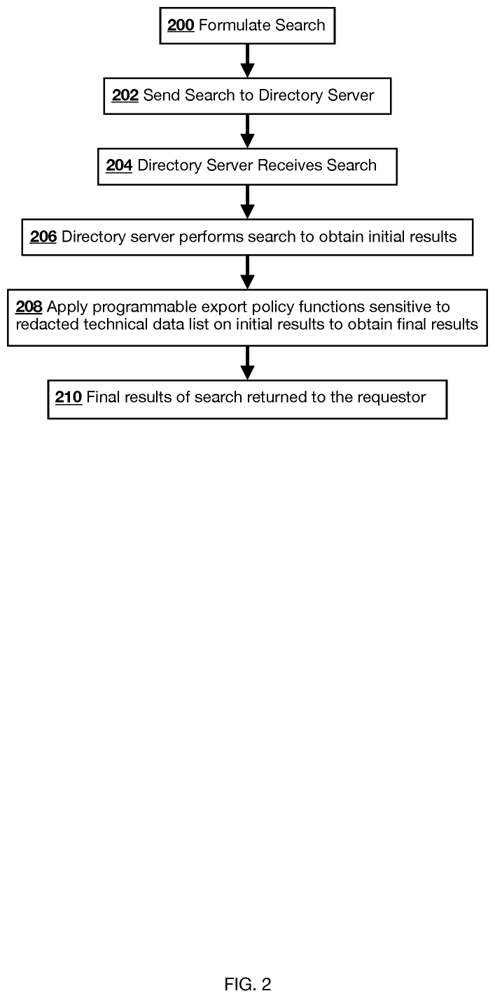

FIG. 2 shows a method in accordance with one embodiment of the invention. Initially, a proposed business activity executing on a processing device formulates a search 200. In one embodiment of the invention, formulating the search includes specifying a search criteria (e.g., criteria used to assess a set of key variables associated with the various classes of export to select one or more classes-of-export in the storage server operatively connected to the processing device). In addition, formulating the search may also include specifying a version of programmable export policy which includes functionality to limit the results of the search based on an SubjectToRestriction attribute (described above). A programmable export policy is a way to specify extension information. Programmable export policies which are sent as part of a request apply only to that request and are not saved. In particular, the programmable export policy may be used to define additional operations which are to be performed by the storage server prior to returning results back to the requesting proposed business activity (via the client).

Once the search has been formulated, the search is forwarded to the storage server 202. The storage server receives the search 204. The storage server subsequently performs a search to obtain initial results 206. In one embodiment of the invention, the initial results correspond to the results that match the search criteria as defined during the formulation of the search 200, wherein a set of key variables associated with the various classes of export is assessed to determine the matching. In one embodiment of the invention, the initial results correspond to the entire classes-of-export including, but not limited to, multiple controlled items associated with each of the classes-of-export.

The programmable export policy comprises a red flag function (specified during the formulation of the search) which is subsequently applied to the initial results to obtain final results 208. In one embodiment of the invention, applying programmable export policies to the initial results includes querying each of the SubjectToRestriction controlled items defined in the storage and determining which controlled items are subject to export restrictions. The result of the aforementioned querying is a redacted technical data list. The controlled items listed in each of the classes-of-export in the initial results are subsequently compared with the list of redacted technical data. Any controlled item in a class-of-export in the initial results that is on the redacted technical data list is removed from the initial search results. Thus, the only controlled items included in the final results are the controlled items in which the proposed business activity has been requested for that are not subject to export restrictions. By removing the controlled items subject to export restrictions, the amount of data transferred between the storage server and the client redaction system is reduced. In addition, the proposed business activity does not need to perform an additional search on the client redaction system to determine which controlled items the proposed business activity is requesting for that are not subject to export restrictions, thereby reducing the computations required on the client redaction system. The final results are subsequently returned to the proposed business activity via the client redaction system 210.

For example, consider a search formulated by proposed business activity 1 which includes search criteria and a version of programmable export policy in accordance with one embodiment of the invention. In this particular example, controlled item 1, 2 and 3 are listed on the storage device, wherein only controlled item 1 is subject to export restrictions. Further, class-of-export 1 is associated with controlled items 1 and 2. Similarly, class-of-export 2 is associated with controlled items 1 and 3. Further, class-of-export 3 is associated with controlled item 2. Further, assume that the search criteria resulted in class-of-export 1 and class-of-export 2 satisfying the search criteria. Thus, the initial result would include the portions of the class-of-export 1 and the class-of-export 2 which include multiple controlled items. At this stage, the initial result has not been communicated to proposed business activity 1. The control, specified in the search formulated by proposed business activity 1, subsequently triggers the storage device to query the controlled items (i.e., controlled item 1, controlled item 2, controlled item 3) listed in the storage and determine which controlled items are subject to export restrictions. In this particular example, only controlled item 1 is subject to export restrictions (as indicated by the SubjectToRestriction attribute in the controlled item 1). Thus, controlled item 1 is placed on a redacted technical data list (or alternatively, maintained in memory associated with the storage device while the storage device is applying the programmable export policy to the initial result). After applying the programmable export policy to the initial result, the controlled items associated with the classes-of-export that are on the redacted technical data list (i.e., controlled item 1 for class-of-export 1 and 2) are removed from the initial result. Thus, the final result includes the classes-of-export (i.e., class-of-export 1, 2 and 3) and only the controlled items (i.e., controlled item 2 for class-of-export 1 and 3, controlled item 3 for class-of-export 2) with which the proposed business activity is requesting for. The final result is communicated to proposed business activity 1 via the client redaction system.

In another embodiment of the invention, the programmable export policy may include an explicit list of controlled items which are approved for the proposed business activity. Thus, when a proposed business activity requests one or more controlled items, the request would include search criteria as well as a version of programmable export policy which includes the list of controlled items associated with the proposed business activity. The storage device, upon receiving such a request, obtains an initial result using the search criteria and then obtains the final result by comparing the controlled items associated with the classes-of-export in the initial result with the controlled items listed in the control. For each class-of-export, if the controlled item in the class-of-export matches the one or more controlled items associated with the requesting proposed business activity, then the class-of-export is included in the final results. Once all classes-of-export in the initial result have been processed, the final result is forwarded to the requesting proposed business activity (via the client redaction system executing the proposed business activity).

In embodiments consistent with the subject matter of this disclosure, the code based on the plaintext item may be calculated based on a desired plaintext data item and a transformation expression.

FIG. 3A illustrates an exemplary B-tree which may be used as an indexing structure in embodiments consistent with the subject matter of this disclosure. The exemplary B-tree may include index nodes 302, 312, 320, 326, 328, 330, 332, 334, 336, 338, 340, and 342. Each of the index nodes may include one or more entries. The index nodes, which are not leaf nodes, may include one or more links to other index nodes. For example, index node 302 may include a number of entries and may further include links to other index nodes, such as index nodes 312, 320, 326 and 328. Index node 312 may include a number of entries and may further include links to other index nodes, such as index nodes 330, 332 and 334, which in this example, may be leaf nodes. Index node 320 may include at least one entry and a link to index nodes 336 and 338, which in this example, may be leaf nodes. Index node 326 may include at least one entry and a link to index node 340, which in this example may be a leaf node. Index node 328 may include at least one entry and a link to index node 342, which in this example may be a leaf node.

FIG. 3B illustrates a more detailed view of exemplary index nodes 302, 312 and 320 of FIG. 3A consistent with the subject matter of this disclosure. In this exemplary B-tree indexing structure, each entry in the index nodes may include a duplet. However, duplets may be used with other indexing structures in other embodiments. As shown in FIG. 3B, each index node may include one or more items and each of the one or more items may include a duplet. For example, index node 302 may include a first item having a duplet including an index value, which may be a code such as, for example, 33567, which may be a value based on transformation of a first plaintext item, and an expression, ‘staff.address.zip’, corresponding to what the transformation applies to the first plaintext item to obtain the index value, a second item having a duplet including an index value, which may be a code, such as, for example, 58957, which may be a value based on transformation of a second plaintext item, and an expression, ‘vendor.address.zip’, corresponding to what the transformation applies to the second plaintext item to obtain the index value, and a third item having a duplet including an index value, which may be a code, such as, for example, 97460, which may be a value based on transformation of a third plaintext item, and an expression, ‘customer.address.zip’, corresponding to what the transformation applies to the third plaintext item to obtain the index value. As can be seen in FIG. 3B, index node 312 may include two entries. A first entry of index node 312 may include a duplet having an index value, 16485, based on a fourth plaintext item and an expression, ‘customer.address.zip’, corresponding to what the transformation applies to the third plaintext item to obtain the index value. A second entry of index node 312 may include a duplet having an index value, 20945, based on a fifth plaintext item and an expression, ‘customer.address.zip’, corresponding to what the transformation applies to the fifth plaintext item to obtain the index value. Index node 320 may include one entry including a duplet. The duplet may include an index value, 46789, based on a sixth plaintext item and an expression, ‘vendor.address.zip’, corresponding to what the transformation applies to the sixth plaintext item to obtain the index value.

Index node 302 may include a link 304, which may be a link to index node 312 having entries with corresponding index values less than index value 33567 of index node 302, a link 306, which is a link to index node 320 having an entry with a corresponding index value greater than index value 33567 and less than index value 58957 of index node 302, a link 308, which may link index node 302 to index node 326 having one or more entries with respective index values greater than index value 58957 and less than index value 97460 of index node 302, and a link 310, which may link index node 302 to an index node 328 having one or more entries with respective index values greater than index value 97460 of index node 302.

Further, index node 312 may include a link 314 to index node 330, which may include one or more entries having index values less than index value 16485 of index node 312, a link 316 to index node 332, which may include one or more entries including index values greater than index value 16485 and less than index value to 20945 of index node 312, and a link 318 to index node 334, which may include one or more entries including index values greater than index value 20945 of index node 312. Index node 320 may include a link 322 to index node 336, which may include one or more entries including index values less than index value 46789 of index node 320, and a link 324 to index node 338, which may include one or more entries including index values greater than index value 46789 of index node 320.

Each of the index node entries may include information indicating a data type of the corresponding plaintext data item (not shown) and may include a reference or pointer to corresponding non-deterministically encrypted ciphertext of an encrypted attribute of the CryptoJSON record (not shown). Further, each of the index nodes may include a different number of items than as shown in the exemplary indexing structure of FIG. 3B. For example, index nodes 302, 312, or 320 may have a different number of items included within the respective index nodes than as shown in FIG. 3B.

The indexing structure of FIGS. 3A and 3B is an exemplary indexing structure. Although, FIG. 3B illustrates each item of the exemplary indexing structure including an index value and an expression, in other embodiments, each item of an indexing structure may include an index value, with a corresponding expression residing in a separate data structure. For example, exemplary index node 302′ of FIG. 3C is similar to index node 302 of FIG. 3B. However, each of the items of index node 302′ may include a first entry of a duplet, which in this example is an index value, and a reference or pointer to a corresponding expression included in a data structure 360, which may be a table, an array, or other data structure. Although data structure 360 illustrates the expressions, corresponding to index node 302′, being in consecutive locations within data structure 360, the expressions may be arranged in locations within data structure 360, which are not consecutive or contiguous.

In embodiments consistent with the subject matter of this disclosure, an indexing structure, such as, for example, the indexing structure of FIGS. 3A-3C, may be updated by controlled item storage system 132 by adding an item to an index node or by adding a new index node that includes a new item, such that links corresponding to the new item in the indexing structure perform in the manner illustrated in FIGS. 3A-3C. That is, each new item added to a node in the indexing structure, which is not a leaf node, may have a link pointing to an index node including one or more items having a respective indexing value that is less than the indexing value of the added item and a second link pointing to an index node including one or more items having a respective indexing value that is greater than the indexing value of the added item. Further, when a new index node is added to the indexing structure, controlled item storage system 132 may update at least one of the existing links of the indexing structure to point to the new index node. Each new item that controlled item storage system 132 may add to the indexing structure may include a respective index value and either a corresponding expression or a reference to a corresponding expression. When a reference to a corresponding expression is stored in an item of the indexing structure, the corresponding expression may be stored in a separate data structure, such as, for example, a table, an array, or other data structure.

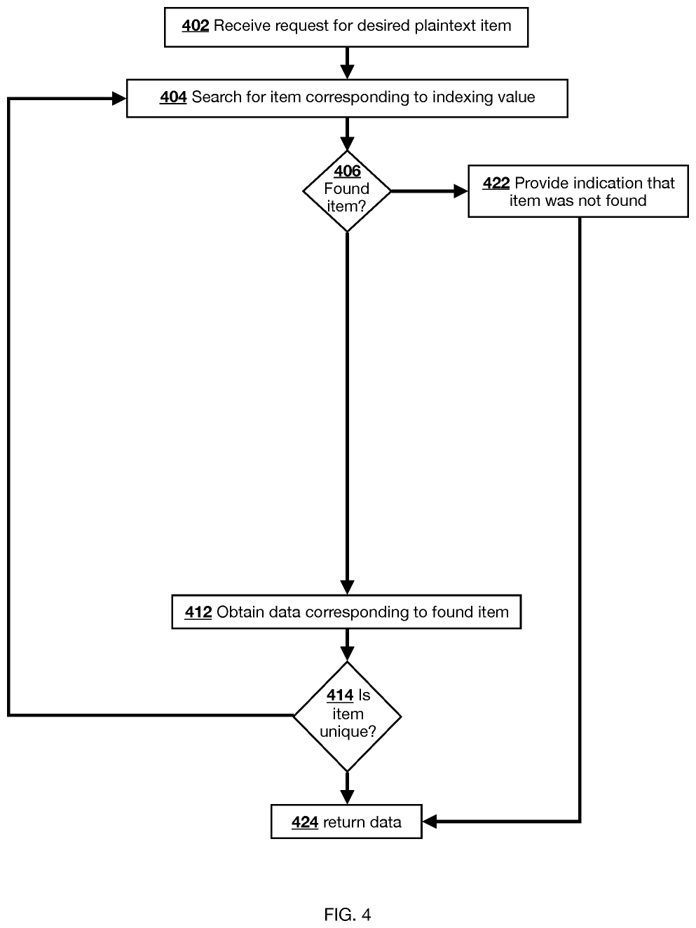

FIG. 4 is a flowchart that illustrates an exemplary process for using an indexing structure, such as, for example, the exemplary indexing structures of FIGS. 3A-3C, to search for non-deterministically encrypted data in a CryptoJSON recordset in embodiments consistent with the subject matter of this disclosure. First, controlled item storage system 132 may receive a request for a desired data item that may be included in a CryptoJSON recordset of controlled item storage system 132 (act 402). The request may be from a requester such as, for example, a user or a proposed business activity of controlled item storage system 132 or from a requester such as, for example, a user or a proposed business activity of another processing device, such as, for example, redaction system 102, which may communicate with controlled item storage system 132 via a network, such as, for example, network 136. The request may be a search request or other request that includes finding a desired data item and may include a plaintext form of the desired data item. Given the desired plaintext data item, controlled item storage system 132 may access and search an indexing structure of the CryptoJSON recordset in an attempt to locate data corresponding to the desired plaintext data item (act 404). If the indexing structure is, for example, a B-tree, controlled item storage system 132 may examine index values of duplets within index nodes of the B-tree to traverse the B-tree in the attempt to locate the desired data.

Next, controlled item storage system 132 may determine whether the desired item was found (act 406). If the desired item was not found, then controlled item storage system 132 may return an indication that the desired data was not found in the CryptoJSON recordset (act 422). Otherwise, the data corresponding to the found item within the indexing structure may be obtained from the CryptoJSON recordset and may be returned to the requester (act 412). That is, the found item of the indexing structure may include a reference to the corresponding data stored in the CryptoJSON recordset. Controlled item storage system 132 may then determine whether the found data item is unique (act 414). In one implementation, controlled item storage system 132 may determine whether the found data item is unique based on whether the found data item is a primary key in a CryptoJSON recordset, based on a uniqueness indicator that may be included in the CryptoJSON recordset or in an entry of an indexing structure, or based on other criteria. If controlled item storage system 132 determines that the found data item is unique in the CryptoJSON recordset, then the process is completed. Otherwise, controlled item storage system 132 may search the indexing structure for a next item corresponding to the indexing value (act 420).

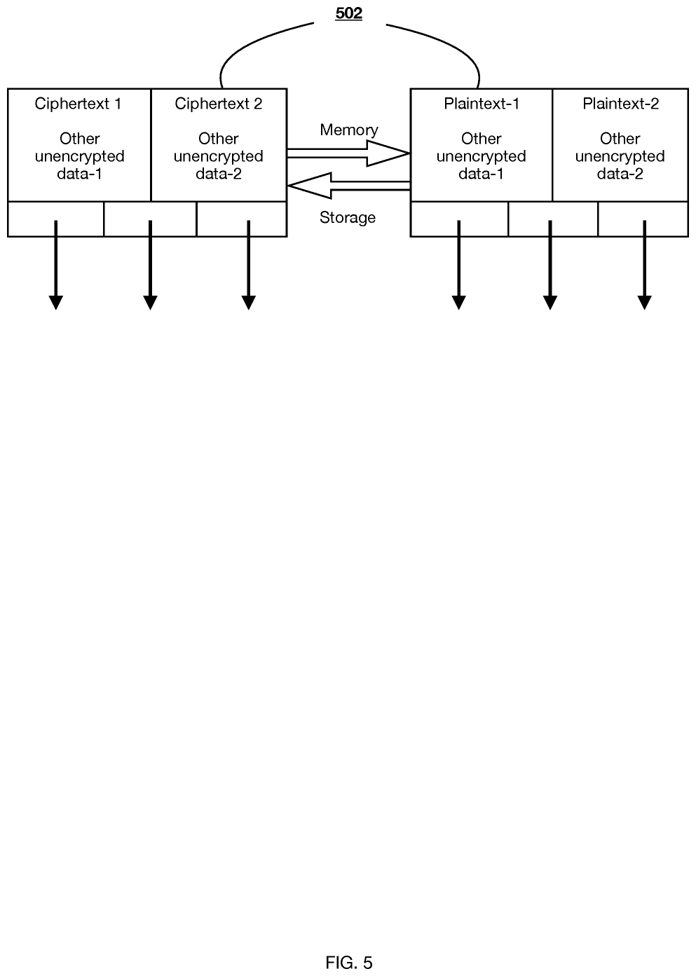

FIG. 5 illustrates another exemplary indexing structure which may be used in another embodiment consistent with the subject matter of this disclosure. FIG. 5 illustrates an exemplary B-tree indexing structure, although other indexing structures may be used in other embodiments. A portion of indexing structure 502 on the right side of FIG. 5 illustrates an index node of indexing structure 502 as it may be when it resides in memory. Indexing structure 502 in memory may include nodes built using plaintext items as index values. Each node may include an index value, or plaintext item, as well as other data pertaining to the plaintext item, along with other unencrypted data. For example, node 502, in memory, may include two items, a first item may include a respective plaintext item, plaintext-1, as an index value and other data related to the plaintext item, and unencrypted data-1, which may be other unencrypted information of the first item. A second item of node 502 may include another respective plaintext item, plaintext-2, as an index value and other data related to the plaintext item, and unencrypted data-2, which may be other unencrypted information of the second item. For example, if the indexing structure is built for searching vendor zipcodes in a CryptoJSON recordset, the index values may be the vendor zipcodes. Searching on such an indexing structure may be performed by traversing the indexing structure until the desired zipcode is found in a node of the indexing structure or until a determination can be made that the desired zipcode is not included in the CryptoJSON recordset when the desired zipcode is not found.

The left side of FIG. 5 illustrates indexing structure 502 as it may be when saved in storage within the CryptoJSON recordset system. The saved version of indexing structure 502 may include encrypted versions of all plaintext references, for example, ciphertext-1 of the first item of node 502 and ciphertext-2 of the second item of node 502. That is, all plaintext references, including the index values, may be saved in encrypted form while the organization of the indexing structure remains unchanged. In other words, an order of items in index nodes and the linkages between nodes may be arranged according to the plaintext index values although all plaintext references, including the index values, may be saved in encrypted form. Further, any other information related to a plaintext item that may be used by the index, such as, for example, plaintext statistics, may also be encrypted. The plaintext references used by the indexing structure, including the information related to a plaintext item, may be encrypted in the saved indexing structure by using the same key that was used to encrypt the corresponding data in the CryptoJSON recordset or by another key.

FIG. 5 illustrates an exemplary node of an indexing structure having two items. In other embodiments, more or fewer items may be stored within a node of the indexing structure.

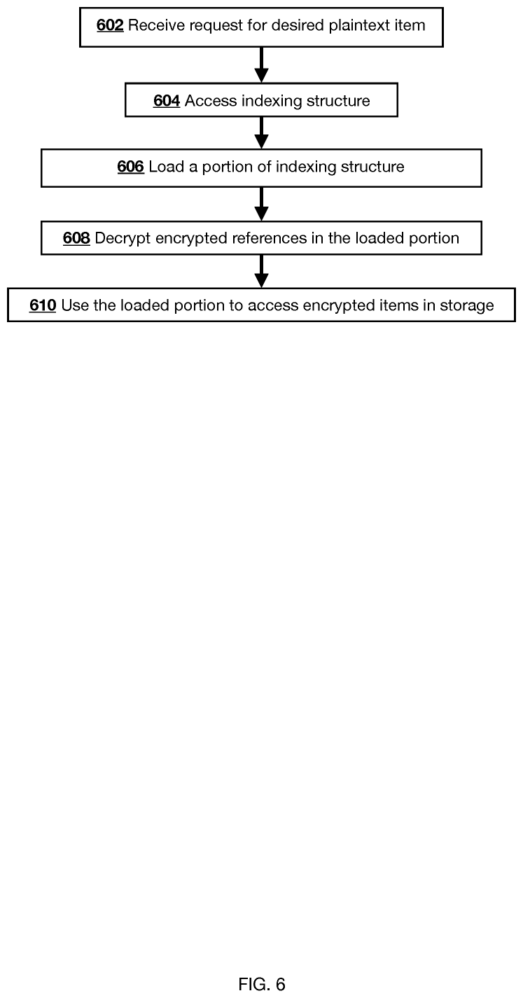

FIG. 6 is a flowchart that illustrates an exemplary process for using an indexing structure, such as, for example, the exemplary indexing structure of FIG. 5, to search for non-deterministically encrypted data in a CryptoJSON recordset in embodiments consistent with the subject matter of this disclosure. First, controlled item storage system 132 may receive a request for a desired data item that may be included in a CryptoJSON recordset of controlled item storage system 132 (act 602). The request may be made directly by a requester such as, for example, a user or a proposed business activity, via controlled item storage system 132 or via another processing device, such as redaction system 102 via a network, such as network 136. The request may be a search request and may include a plaintext form of the desired data item. Next, controlled item storage system 132 may access an indexing structure of the CryptoJSON recordset in order to perform a search for data in the CryptoJSON recordset that corresponds to the desired data item (act 604). Controlled item storage system 132 may then load at least a portion of the indexing structure into dynamic storage, such as memory 143 (act 606). Controlled item storage system 132 may then decrypt encrypted references in the loaded portion of the indexing structure (act 608) and may use the loaded portion of the indexing structure to find and access one or more non-deterministically encrypted data items in the CryptoJSON recordset (act 610).

In one embodiment, controlled item storage system 132 may decrypt the encrypted references of the indexing structure as an index page or portion of the indexing structure is loaded into memory 143. In such an embodiment, searching may then be performed using the corresponding plaintext references and other information from the indexing structure. In another embodiment, the plaintext references from the indexing structure may be decrypted as the search is performed, such as, for example, when a plaintext reference from the index is needed.

The exemplary method described above, with reference to FIG. 6, may be used to search for data pertaining to a particular data item, such as, for example, an equality search, may be used to search for data pertaining to a range of data values, such as, for example, a range search, or may be used to perform a search for information that is similar to a particular data item, such as, for example, a fuzzy search.

Vendor Access Assignment to Zones

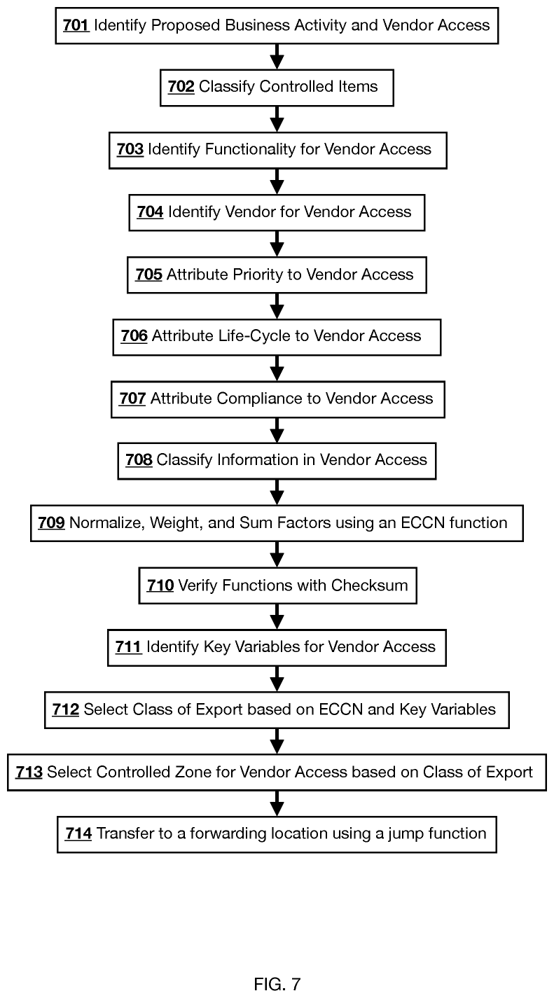

FIG. 7 illustrates the operation of export review management system 114 when assigning vendor access to a zone in an example of the invention. The reference numbers from FIG. 7 are indicated parenthetically below. Typically, the zone assignment is accomplished by an export team interacting with export review management system 114 through its GUI. To determine the zone assignment, the vendor access is first analyzed to determine various factors for the vendor access.

Export review management system 114 starts the process by identifying an proposed business activity and by identifying the vendor access for the proposed business activity 701. Typically, the export team will identify proposed business activities and their vendor access for entry into export review management system 114. A proposed business activity is any functionality in computer network 100 that transfers controlled items 107. The controlled items 107 for the proposed business activity can be separated into identifiable vendor access. A single proposed business activity can have one vendor access or multiple vendor access. For example, the proposed business activity could be a customer support service that has individual vendor access for customer information, and performance information.

Export review management system 114 manages proposed business activity status in some examples of the invention. To accomplish this task, export review management system 114 interacts with an export team through its GUI to provide proposed business activity status and implementation information. Many proposed business activities require Export Review before the activity can take place, and some that generally do not. For example, a list of common activities could be:

Activity #1-Interactions with Vendors, Customers, or other Third Parties.

Activity #2-Technology Development and Publishing.

Activity #3-Hiring.

Activity #4-Physical Exports.

Activity #5-Activities in the Standard Setting or Development Context.

Note that the activities could be further broken down into more specific scenarios. For example, the above list of common activities could be separated as follows:

Activity #1a—Engaging a vendor through a master agreement and/or statement of work (“SOW”) for a Technology development project or for technical support.

Activity #1b—For existing agreements, whenever any new hardware, location, or worker nationality is added to an engagement, or the Controlled Item being shared has been significantly revised (e.g., release of a major software build).

Activity #1c-Any other arrangement that involves technical collaboration with a third party.

Activity #1d-Issuing a company-owned laptop to any vendor or contractor for a technical role.

Activity #1e-Allowing an outside visitor to inspect Controlled Items at a company-owner site.

Activity #2a-Allowing external users anywhere to access, download, or view software or Technology residing on company-owned systems (e.g., posting code to GitHub or other shared repositories).

Activity #2b-Publishing apps or software that are available in other countries, including through third party stores (e.g., Apple App Store).

Activity #2c—Publishing apps or libraries that include proprietary (i.e., not open source) encryption code or functions.

Activity #2d-Modifying the encryption function of open source software (“OSS”).

Activity #2e-Using software or Technology that qualifies as open source per the company-issued Open Source Software Guidelines.

Activity #3a-Hiring an employee, contractor, or intern for a technical role (e.g., developer, engineer)—see list of Export-Restricted Job Families.

Activity #3b—Sponsoring a candidate for an H1-B Visa (U.S. only).

Activity #4a—Shipping Controlled Items across an international border, including shipments of equipment to be repaired or serviced, replacement equipment, and/or test equipment or software—even if the shipment is going to an internal employee or location and the recipient is a U.S. Person.

Activity #4b-Installing Controlled Items on a customer, vendor, or end user's system(s).

Activity #4c-Hand-carrying Controlled Items (including data on laptops or smartphones) across an international border, except for devices for personal or professional use by the traveling employee.

Activity #4d-Contractors traveling internationally with Company-owned devices.

Activity #5a—Participation in standards-setting organizations that involve the exchange of Technology, both formally and informally, through meetings and technical discussions, the draft and review of position papers, creation and review of presentations, and examination of datasets and other materials.

Activity #5b—Presenting topics at conferences that go beyond published material.

Export review management system 114 could retrieve the current status of the various proposed business activities and systems from another system, or the export team could enter the status for each activity and system. Advantageously, export review management system 114 enables the export team to obtain a quick but effective view of the planning and development of export-controlled CryptoJSON infrastructure 110.

For a given vendor access, export review management system 114 classifies the controlled items for the vendor access 702.

For a classified vendor access, export review management system 114 identifies a functionality for the vendor access 703. The functionality represents the reason for the vendor access. To identify a functionality for the vendor access, the export team is given a choice of functions through some other GUI mechanism. All vendor access are attributed with functionality from a consistent set of functions.

For a given vendor access, export review management system 114 identifies a vendor for the vendor access 704. The vendor represents the entity in computer network 100 that needs the controlled items for the vendor access. To identify a vendor for the vendor access, the export team is given a choice of vendors through some other GUI mechanism. All vendor access are attributed to vendors from a consistent set of vendors.

Export review management system 114 attributes a priority to the vendor access 705. The priority represents the importance of the vendor access to the computer network 100 in terms of access delay, geographically diverse back-up, and disaster recovery. To attribute a priority to the vendor access, the export team is given a choice of priority levels for each vendor access through some other GUI mechanism. All vendor access are attributed with a priority from a consistent set of priority levels.

Export review management system 114 attributes a life-cycle to the vendor access 706. The life-cycle represents a time period during which the vendor access retains value to communications network 100. To attribute a life-cycle to the vendor access, the export team is given a choice of time periods for each vendor access through some other GUI mechanism. All vendor access are attributed with a life-cycle from a consistent set of time periods.

Export review management system 114 attributes compliance requirements to the vendor access 707. The compliance requirements indicate if the vendor access needs to be kept for legal purposes. To attribute compliance requirements to the vendor access, the export team is given a choice of compliance types for each vendor access through some other GUI mechanism. All vendor access are attributed to compliance requirements from a consistent set of compliance types.

The vendor access may also be associated with other factors in a similar manner. In addition, some of the factors described above could be omitted.

For a given vendor access, export review management system 114 classifies the information represented by the controlled items 708.

To classify the information in the vendor access, export review management system 114 provides the export team with a choice of information classes for each vendor access through some other GUI mechanism. All vendor access are classified into a consistent set of information classes.

The above factors are data class, functionality, vendor, priority, life-cycle, compliance, and information class. As noted, the factors that management system 114 makes available for selection are controlled and consistent. Each factor that is available for selection has a corresponding score. For example, the life-cycle factors and their scores could be:

Life-cycle #1-less than 7 days: score=1.

Life-cycle #2-8 days to 31 days: score=2.

Life-cycle #3-32 days to one year: score=3.

Life-cycle #4-one year to five years: score=4.

Life-cycle #5-greater than five years: score=5.

For a given vendor access, a programmable export policy may include an ECCN function written in a machine language, such as javascript, that a processing device 140 can understand and execute. For example, such an ECCN function may add together the scores for all of the vendor access factors to calculate a numerical representation of an ECCN for the vendor access 709. Different versions of the programmable export policy may change the way in which an ECCN is calculated, and therefore a processing device always verifies an export policy file using a checksum function to help ensure the version of the export policy and the functions contained therein are unaltered, and the functions may not run if it cannot be verified by the checksum function 710. Prior to summing to the numerical representation of an ECCN, the individual scores may be normalized. For example, the life-cycle scores could be normalized by dividing by 5, so that all life-cycle scores are between zero and one. Prior to summing the numerical representation of an ECCN, the individual scores may be weighted to emphasize or de-emphasize a given factor. For example, life-cycle scores could be multiplied by 1.5 to increase the importance of the life-cycle factor relative to the other factors, but priority scores could be multiplied by 0.5 to decrease the importance of the priority factor relative to the other factors. Once the individual scores are normalized and weighted, the normalized and weighted individual scores are summed to obtain the numerical representation of an ECCN for the vendor access.

For the vendor access, a set of key variables is assessed to determine compatibility between the vendor access and the various classes of export 711. In this example the classes of export are: extremely critical, mission critical, business critical, and redaction/reporting, although different classes-of-export could be used. The key variables are:

Access Frequency-what is the amount of access to the data that will be needed during a given time period.

Archival and Deletion-does the data need to be stored for more than a given time period and does the data need to be deleted at a given time in the future.

Control Plan-what type of security measure is necessary to prevent unauthorized transfers of controlled items to persons or entities subject to Export restrictions.

Government License—are there any license requirements for the recipient countries.

Restricted Destinations List-any countries or territories that are currently the subject of restrictions can be found on the Restricted Destinations List.

Connectivity-what type of Input/Output (I/O) is required for data access.

Data Migration-what percent of the data must be ported to other systems.

Policy Enforcement—are there policies regarding the ability to change or delete the data.

Geographic Locations-how many storage sites are required for the data.

Business Impact—is there a significant business impact if the data is lost.

Export review management system 114 selects the class of export for the vendor access based on the key variables and the ECCN 712. For example, once the variables are selected for the vendor access, export review management system 114 compares the vendor access variables against the class-of-export variables to determine which classes-of-export are suitable for the vendor access. The ECCN is used to select from among the suitable classes of export. For example, both the extremely critical and mission critical classes-of-export may be suitable for a given vendor access. The extremely critical class-of-export may be used if the vendor access has a ECCN numerical representation higher than 10 and the mission critical class-of-export may be used if the vendor access has a ECCN numerical representation of 10 or lower.

For a given vendor access, export review management system 114 selects a zone based on the selected class of export 713. Typically, each class-of-export is pre-assigned to a zone. New zones and classes-of-export may be implemented over time. For the vendor access, a programmable export policy may include programmable functions written in a machine language, such as javascript, that a processing device 140 can understand and execute. For example, for the given vendor access, a programmable jump function may suggest a forwarding location that is not a subject of restrictions found on the Restricted Destinations List, and subsequently change a controlled item's location to a different zone 714. Further, an intervention function may redirect a second sender employee to an approved vendor access of controlled items which are approved for a proposed business activity, where the second sender employee has a different nationality than a first existing sender employee associated with the vendor access in the same base country, thereby conferring additional business advantages, such as favorable conditions for receiving employment-based visas by the second sender employee. The redirection may be a suggestion made to senior management that the export team will have no knowledge of. A checksum function verifies the “effective date” or “last revised date” of an export policy file, and the intervention function may not run if the “effective date” or “last revised date” cannot be verified by the checksum function 710. Advantageously, a programming export policy may use a combination of the various functions to authorize vendor access from a recipient location to a controlled item's current location.

1. A method for performing a search on non-deterministically encrypted export controlled items in a CryptoJSON recordset system operated by an export team within a corporate asset infrastructure, wherein a programmable export policy comprises a plurality of functions that may change the ways in which the search is performed for a vendor access, the method comprising:
determining, transparently to a vendor, an indexing value for a desired plaintext item of data provided by the vendor, the indexing value being based, at least partially on the desired plaintext item of data, a transformation expression and a redacted technical data list;
executing an ECCN function included in the plurality of functions to calculate a numerical representation of an ECCN for the vendor access, wherein the ECCN function calculates the numerical representation based on normalized and weighted scores for all factors associated with the vendor access;
executing a search operation to obtain initial results, wherein the initial results comprise a plurality of classes-of-export that match a search criteria and a plurality of controlled items associated with the plurality of classes-of-export that match the search criteria, wherein the search criteria includes the numerical representation and a plurality of key variables, the plurality of key variables include at least one of Access Frequency, Archival and Deletion, Control Plan, Government License, Restricted Destinations List, Connectivity, Data Migration, Policy Enforcement, Geographic Locations, and Business Impact;
executing a jump function included in the plurality of functions to move the plurality of controlled items to a forwarding location that is not a subject of restrictions found on the Restricted Destination List key variable;
executing a red flag function included in the plurality of functions to obtain final results, wherein the final results comprise a subset of the plurality of controlled items associated with each of the plurality of classes-of-export that match the search criteria, wherein the red flag function comprises functionality to query an attribute for each of the plurality of controlled items to obtain the redacted technical data list wherein each of the plurality of controlled items listed on the redacted technical data list are subject to export restrictions, and discard any of the plurality of controlled items that are in the redacted technical data list to obtain the subset of the plurality of controlled items;
executing an intervention function included in the plurality of functions to determine a redirection of a sender employee to the final results based on nationality of the sender employee, wherein the nationality is determined to confer advantages to the proprietary business strategies, wherein the determination is accomplished without involving the export team; and
using the indexing value to access a corresponding entry in an indexing structure to obtain a CryptoJSON recordset entry including non-deterministically encrypted ciphertext corresponding to the desired plaintext item of data.

2. The method of claim 1, wherein the determining of the indexing value for a desired plaintext item of data further comprises:
calculating the indexing value based on applying the transformation expression to the desired plaintext item of data.

3. The method of claim 1, wherein the indexing structure includes at least a first item of each of a plurality of paired data items, the first item of each of the plurality of paired data items being an indexing data item having a value based on a respective plaintext data item and the transformation expression and a second item of each of the paired data items being the transformation expression corresponding to what may be applied to the respective plaintext data item to obtain the indexing value.

4. The method of claim 1, wherein the indexing structure includes at least a first item of each of a plurality of paired data items, the first item of each of the plurality of paired data items being an indexing data item having a value based on a respective plaintext data item and the transformation expression and a second item of each of the paired data items being a pointer to a data structure comprises the transformation expression corresponding to what may be applied to the respective plaintext data item to obtain the indexing value.

5. The method of claim 1, wherein the indexing structure includes a B-tree.

6. A method for providing a remote CryptoJSON recordset for performing a search on non-deterministically encrypted export controlled items in a CryptoJSON recordset system operated by an export team within a corporate asset infrastructure, wherein a programmable export policy comprises a plurality of functions that may change the ways in which the search is performed for a vendor access, the method comprising, the method comprising:
receiving a remote request from a requester, via a network, to search the non-deterministically encrypted controlled items in the CryptoJSON recordset system for a CryptoJSON recordset entry corresponding to a desired plaintext data item provided by a vendor;
determining, transparently to the requester, an indexing value for the desired plaintext data item provided by the vendor, the indexing value being based, at least partially on the desired plaintext item of data, a transformation expression and a redacted technical data list;
executing an ECCN function included in the plurality of functions to calculate a numerical representation of an ECCN for the vendor access, wherein the ECCN function calculates the numerical representation based on normalized and weighted scores for all factors associated with the vendor access;
executing a search operation to obtain initial results, wherein the initial results comprise a plurality of classes-of-export that match a search criteria and a plurality of controlled items associated with the plurality of classes-of-export that match the search criteria, wherein the search criteria includes the numerical representation and a plurality of key variables, the plurality of key variables include at least one of Access Frequency, Archival and Deletion, Control Plan, Government License, Restricted Destinations List, Connectivity, Data Migration, Policy Enforcement, Geographic Locations, and Business Impact;
executing a jump function included in the plurality of functions to move the plurality of controlled items to a forwarding location that is not a subject of restrictions found on the Restricted Destination List key variable;
executing a red flag function included in the plurality of functions to obtain final results, wherein the final results comprise a subset of the plurality of controlled items associated with each of the plurality of classes-of-export that match the search criteria, wherein the red flag function comprises functionality to query an attribute for each of the plurality of controlled items to obtain the redacted technical data list wherein each of the plurality of controlled items listed on the redacted technical data list are subject to export restrictions, and discard any of the plurality of controlled items that are in the redacted technical data list to obtain the subset of the plurality of controlled items;
executing an intervention function included in the plurality of functions to determine a redirection of a sender employee to the final results based on nationality of the sender employee, wherein the nationality is determined to confer advantages to the proprietary business strategies, wherein the determination is accomplished without involving the export team;
using an index to an indexing structure to obtain the CryptoJSON recordset entry corresponding to the desired plaintext data item; and
returning data to the requester, the returned data including the CryptoJSON recordset entry corresponding to the desired plaintext data item obtained from the CryptoJSON recordset system.

7. The method of claim 6, further comprises calculating the index based on applying the transformation expression to the desired plaintext item of data.

8. The method of claim 6, wherein the indexing structure comprises a plurality of items, each of the plurality of items including at least a first item of a duplet and a second item of the duplet, the first item of the duplet comprises calculating the index based on a corresponding plaintext data item and the transformation expression, the second item of the duplet comprises the transformation expression corresponding to what may be applied to the respective plaintext data item to obtain the indexing value.

9. The method of claim 6, wherein the indexing structure comprises a plurality of items, each of the plurality of items including at least a first item of a duplet and a reference to a second item of the duplet, the first item of the duplet comprises calculating the index based on a corresponding plaintext data item and the transformation expression, the reference to the second item of the duplet includes a pointer to a data structure including the second item of the duplet, and the second item of the duplet comprises the transformation expression corresponding to what may be applied to the respective plaintext data item to obtain the indexing value.

10. The method of claim 6, wherein the indexing structure includes a B-tree.

11. A CryptoJSON recordset system for performing a search on non-deterministically encrypted export controlled items operated by an export team within a corporate asset infrastructure, wherein a programmable export policy comprises a plurality of functions that may change the ways in which the search is performed for a vendor access, comprising:
a processing device having a processor;
an export review management system deployed on the processing device and operable to execute on the processor, the export review management system operate to:
determine, transparently to a vendor, an indexing value for a desired plaintext item of data provided by the vendor, the indexing value being based, at least partially on the desired plaintext item of data, a transformation expression and a redacted technical data list;
executing an ECCN function included in the plurality of functions to calculate a numerical representation of an ECCN for the vendor access, wherein the ECCN function calculates the numerical representation based on normalized and weighted scores for all factors associated with the vendor access;
execute a search operation to obtain initial results, wherein the initial results comprise a plurality of classes-of-export that match a search criteria and a plurality of controlled items associated with the plurality of classes-of-export that match the search criteria, wherein the search criteria includes the numerical representation and a plurality of key variables, the plurality of key variables include at least one of Access Frequency, Archival and Deletion, Control Plan, Government License, Restricted Destinations List, Connectivity, Data Migration, Policy Enforcement, Geographic Locations, and Business Impact;
execute a jump function included in the plurality of functions to move the plurality of controlled items to a forwarding location that is not a subject of restrictions found on the Restricted Destination List key variable;
execute a red flag function included in the plurality of functions to obtain final results, wherein the final results comprise a subset of the plurality of controlled items associated with each of the plurality of classes-of-export that match the search criteria, wherein the red flag function comprises functionality to query an attribute for each of the plurality of controlled items to obtain the redacted technical data list wherein each of the plurality of controlled items listed on the redacted technical data list are subject to export restrictions, and discard any of the plurality of controlled items that are in the redacted technical data list to obtain the subset of the plurality of controlled items;
execute an intervention function included in the plurality of functions to determine a redirection of a sender employee to the final results based on nationality of the sender employee, wherein the nationality is determined to confer advantages to the proprietary business strategies, wherein the determination is accomplished without involving the export team; and
use the indexing value to access a corresponding entry in an indexing structure to obtain a CryptoJSON recordset entry including non-deterministically encrypted ciphertext corresponding to the desired plaintext item of data.

12. The system of claim 11, wherein the determining of the indexing value for a desired plaintext item of data further comprises:
calculating the indexing value based on applying the transformation expression to the desired plaintext item of data.

13. The system of claim 11, wherein the indexing structure includes at least a first item of each of a plurality of paired data items, the first item of each of the plurality of paired data items being an indexing data item having a value based on a respective plaintext data item and the transformation expression and a second item of each of the paired data items being the transformation expression corresponding to what may be applied to the respective plaintext data item to obtain the indexing value.

14. The system of claim 11, wherein the indexing structure includes at least a first item of each of a plurality of paired data items, the first item of each of the plurality of paired data items being an indexing data item having a value based on a respective plaintext data item and the transformation expression and a second item of each of the paired data items being a pointer to a data structure comprises the transformation expression corresponding to what may be applied to the respective plaintext data item to obtain the indexing value.

15. The system of claim 11, wherein the indexing structure includes a B-tree.
